(19) United States
(12) Patent Application Publication
(10) Pub. No.: US 2008/0196810 A1
(43) Pub. Date: Aug. 21, 2008

(54) RUNFLAT SAFETY BAND INCORPORATING WIRELESS DEVICE

(76) Inventors: Aidrian Simon Nowell, Oxfordshire (GB); Bryn James Dixon, Bletchley (GB); Paul Edward Vickery, Northants (GB)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 12/107,612

(22) Filed: Apr. 22, 2008

(30) Foreign Application Priority Data
Aug. 10, 2007 (GB) GB 0715685.4

(51) Int. Cl. B60C 17/00

(52) U.S. Cl. 152/516

(57) ABSTRACT

A wheel well filler or runflat safety band having a band member with at least one break in it so as to enable it to be fitted onto a wheel. A link member connects the ends of the band member so as to bridge the break and thereby secure the band, in use, on a wheel. A wireless device is attached to the link member, which wireless device is remotely interrogatable in order to confirm the presence of the filler on the wheel.

### BACKGROUND OF THE INVENTION

1. Field of the Invention

The present invention relates to wheel well fillers or runflat safety bands and more particularly to such bands which incorporate a wireless device for remotely confirming the presence of the band on a wheel.

2. The Prior Art

A wheel well filler or runflat safety band is a type of run flat system that can be retro fitted to a standard wheel and which operates to prevent the tire bead from dropping into the wheel well when the tire pressure decreases, either gradually due to a simple puncture or suddenly due to a blowout. Were the bead to drop into the wheel well, the tire could work itself off the wheel. The runflat safety band is engaged into the well of the wheel, allowing the tire bead to move across the wheel when the pressure within the tire drops, but preventing the beads from falling into the wheel well and thereby locking the tire onto the wheel and ensuring that there is always rubber between the wheel rim and the road surface or ground. Thus, steering, braking and cornering control are better maintained and the risk of accident due to tire deflation greatly reduced. The system enables the driver to continue driving after deflation for a short period to a safe place where the wheel can be changed. The distance achieved before the tire breaks up depends on the speed, on the amount of cornering and on surface conditions. There are different designs of band made from metal, or plastic, or a combination of the two, but all are basically composed of a ring, in one or more parts, whose width is equal to the width of the wheel well and which has dimples or inserts which rest on the bottom of the wheel well to space the band radially outwardly from the bottom of the well.

However, since the runflat safety band is mounted inside the wheel well, it is completely concealed within the wheel once the tire is fitted, and hence it is not possible from an external inspection to check whether the band is fitted to the wheel or not, for example after replacement of the tire. With a number of countries proposing regulations requiring the fitment of runflat safety bands to certain categories of vehicles, there is a concern that the authorities will not have a ready means of checking that the runflat safety bands have been fitted.

### SUMMARY OF THE INVENTION

According to the present invention there is provided a wheel well filler or runflat safety band comprising a band member having at least one break or gap in it so as to enable it to be fitted circumferentially onto a wheel and a link member for connecting between ends of the band member so as to bridge the break and thereby secure the band, in use, on a wheel, wherein a wireless device is attached to the link member, which wireless device is remotely interrogatable in order to confirm the presence of the filler on the wheel.

The present invention further provides a link member for a wheel well filler or runflat safety band having ends for connection between ends of at least one band member which forms the wheel well filler/runflat safety band and a wireless device attached to the link member, which wireless device is remotely interrogatable in order to confirm the presence of the filler on the wheel.

A runflat safety band well filler according to the invention has the advantage that the presence of the runflat safety band can easily and reliably be verified via a simple external check, thereby avoiding the possibility of the runflat safety band being left off the wheel. Furthermore, the provision of the device on the link member enables the system easily to be retro fitted onto existing fillers/safety bands as well as to new parts, and also facilitates removal/replacement of the system.

The wireless device is preferably a wireless sensor such as a SAW sensor, and may be fitted within a pressed safety band spacer dimple, fitted to a bracket provided on the safety band, or fitted to the underside of the sensor band. A suitable antenna will be provided on the sensor which may extend radially into the tire cavity.

In a particularly preferred embodiment, the wireless sensor is a pressure and temperature sensor which provides remote indication of the pressure and temperature within the tire, being interrogated to confirm the presence of the runflat safety band on the wheel, the ability to confirm that the tire is running on the runflat band following tire deflation and, because of temperature measurement, indicating that the tire is overheating and likely to break up prematurely whilst running on the runflat band. The apparatus including means for confirming the presence of a runflat safety band on a wheel assembly by emitting an interrogation signal in the region of the wheel assembly and monitoring for a response signal from the wireless device, the detection of a response signal confirming the presence of run flat safety band on the hub.

Preferably the link member comprises a central block on which the wireless device is mounted and two side blocks, on opposing sides of and connected to the central block by arms whose width is smaller than the width of the central and side blocks. Typically the band member of the safety band/filler has hooked ends with a longitudinally extending central slot formed therein, which hooked ends is engageable over the side blocks with the arms engaged in the central slot, thereby enabling particularly easy fitting of the link member to existing systems.

Alternatively, the link member may be formed with a central member on which the wireless device is mounted and threaded shafts extending from opposing sides thereof, which shafts engage through the central slots in the neighboring ends of the band and are secured therein by nuts. This configuration has the advantage that it enables adjustment of the size of the band.

Preferably, the assembly comprises two band members which are arranged in series in a circular shape with proximate ends being connected together to close the circle. One of the joins is then formed by a conventional link whilst the other uses a link member of the invention have a wireless device mounted thereon.

### BRIEF DESCRIPTION OF THE DRAWINGS

In order that the invention may be well understood, Were will now be described some embodiments thereof, given by way of example, reference being made to the accompanying drawings, in which:

FIG. 1A is a perspective view of a conventional runflat safety band.

FIG. 1B is a perspective view of a wheel/tire assembly showing how the tire can skew on the wheel upon deflation.

FIG. 1C is a sectional view through a tire with the runflat safety band of FIG. 1A fitted.

FIGS. 2, 3 and 4 are a series of illustrative views of three embodiments of wireless sensor incorporated into a runflat safety band which do not form part of the present invention.

FIG. 5A is a top plan view of a link member embodying the present invention.

FIG. 5B is a side elevational view of a link member embodying the present invention.

FIG. 6 is a perspective view of a two piece band and link member.

### DETAILED DESCRIPTION OF THE PREFERRED EMBODIMENTS

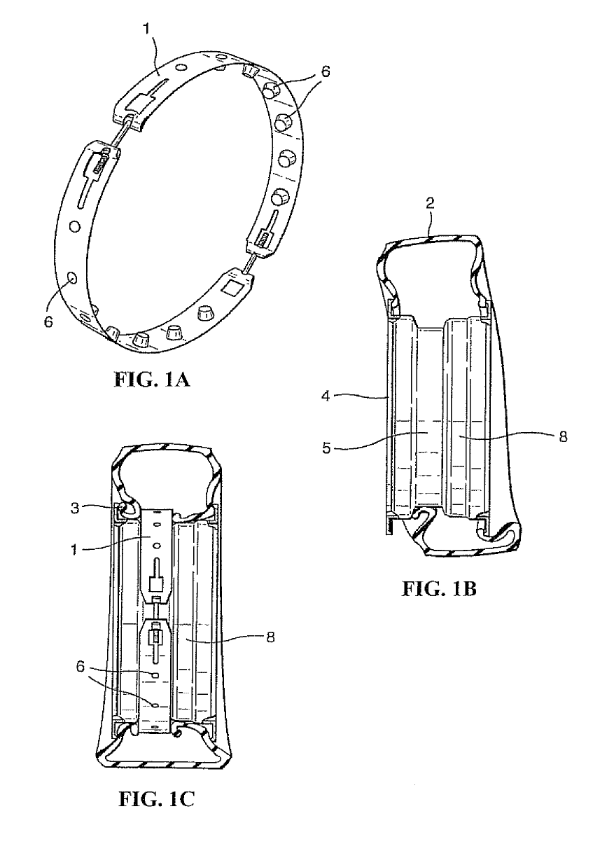

Referring to FIG. 1A, there is shown a runflat safety band 1 which is generally known in the art, for fixing into the well of a wheel in order to prevent skewing of the tire upon deflation during use. As shown in FIG. 1B, upon loss of pressure within the tire 2, the bead 3 can slide across the inner surface of the wheel 4 and drop into the wheel well 5. This further reduces the tension holing the other bead on the rim, allowing the tire to further skew, which results in a severe loss of control to the driver of the vehicle.

The runflat safety band 1 is fitted to the wheel so as to engage in the wheel well as shown in FIG. 1C. The band 1 has inwardly extending studs 6 which engage against the radially inner surface of the well 5 so that the band projects out to the main inner surface 8 of the wheel, thereby preventing the tire bead 3 from sliding across the wheel.

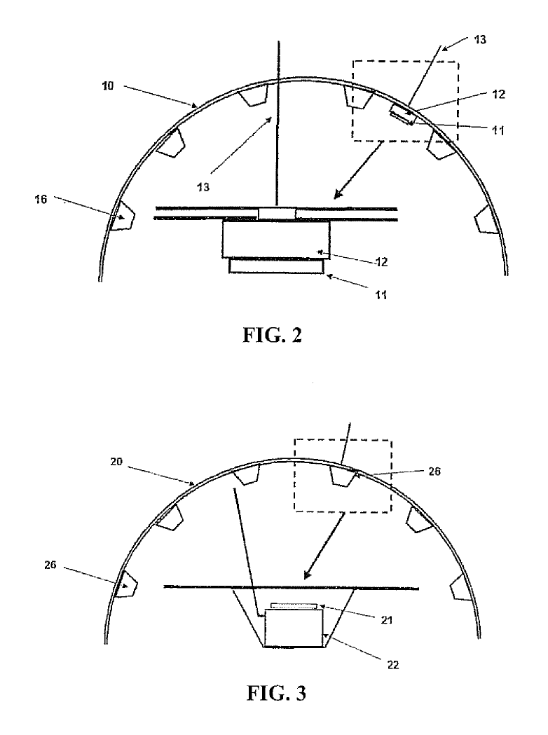

Referring now to FIG. 2, there is shown a runflat safety band 10 according to a first aspect of the invention having a wirelessly interrogatable sensor 11 attached thereto by means of which the presence of absence of the band 10 from the wheel can be ascertained. The sensor 11 is mounted in a housing 12 which is attached to the radially inner surface of the band 10 between a neighboring pair of studs 16. The thickness of the sensor and housing together is less than the height of the studs 16 so that the sensor does not rest against the base of the wheel well 5. An antenna 13 extends radially outwardly from the sensor housing 12, through the band 10 and into the aperture defined between the wheel and the tire.

In an alternative arrangement shown in FIG. 3, the sensor 21 and housing 22 are mounted within one of the studs 26 of the runflat safety band 20, an antenna 23 again extending radially outwardly from the sensor, through the band 20 and into the tire cavity.

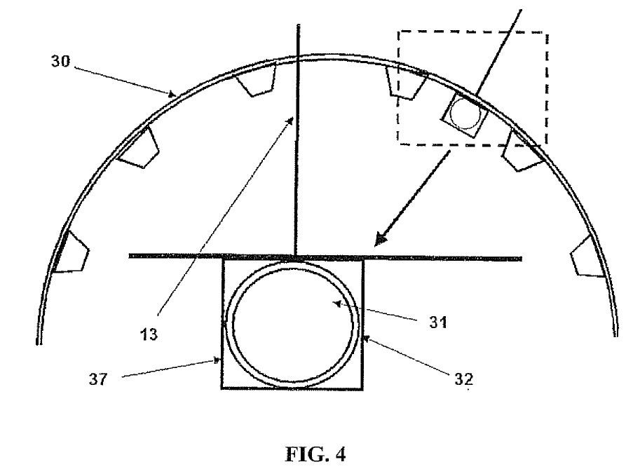

FIG. 4 shows a third embodiment in which the sensor 31 and housing 32 are mounted in a bracket 37 which is again attached to the inner surface of the band 30, with an antenna extending radially outwardly through the band 30.

The sensor should be mounted on the inner surface of the band so that it is protected by the band against damage. Furthermore, other antenna configurations are possible, including electrically coupling the sensor to the band itself such that the band acts as the antenna.

The sensor is programmed to emit a response when interrogated in a manner well known to the person skilled in the art, which response signal is detected as confirmation of the presence of the band on the wheel. Advantageously, the sensor is a SAW sensor which is in fluid communication with the air in the tire such that it also measures operating parameters of the tire such as temperature, pressure and the like. The sensor may then be configured for separate interrogation depending on whether the tire pressure, temperature, running on the runflat band, driving too fast whilst running on the runflat band or the like is required or simply confirmation of the presence of the band. Alternatively, however, the detection of a pressure signal from the sensor can be used to interpret that the sensor, and hence the band, is present.

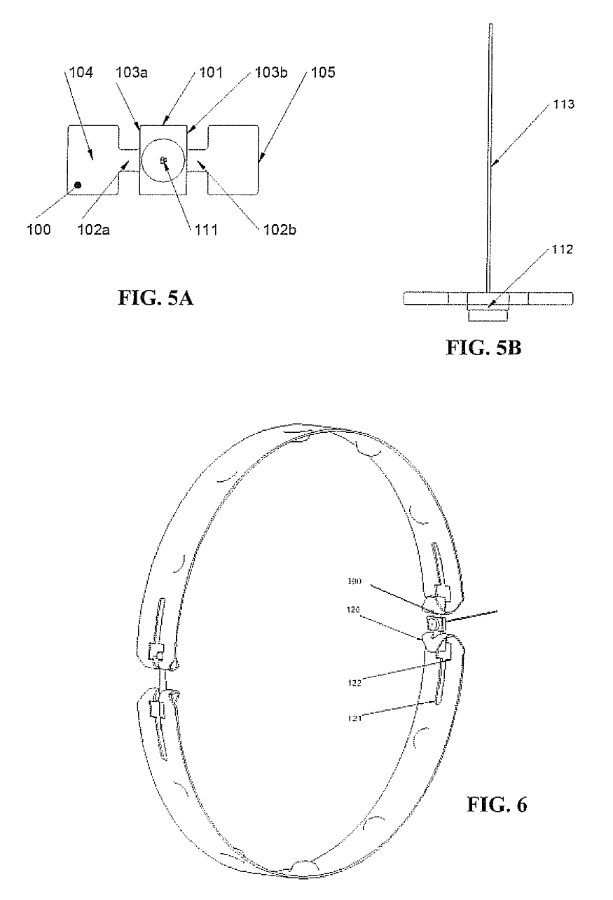

Referring now to FIGS. 5A and 5B, there is shown a link member 100 carrying a wirelessly interrogatable sensor 111 embodying the invention. The link member 100 comprises a central body 101 having a pair of arms 102a, 102b extending longitudinally from opposing sides 103a, 103b such that the arms extending in the direction of the band when the link is connected to thereto. The arms 102a, 102b connect the central body 101 to respective one of a pair of side bodies 104, 105 which are located on either side of the central body 101, the width of the central body 101 in a lateral direction, being substantially equal to the width of the side bodies 104, 105 whilst the arms 102a, 102b are of reduced width compared with the bodies 101, 104, 105. The sensor 111, which comprises one or more SAW devices so as to enable remote monitoring of at least one of temperature and pressure within a tire mounted on a wheel with which the run flat band is used, is mounted on the central body 101 using well known technology so that the sensors are exposed to the fluid environment within the tire. In the illustrated embodiment, the sensor 111 is carried on a mounting plate 112 which is separately formed from and attached to the link member on the underside of the central body 101, an antenna 113 extending through the central body 101 so as to extending radially outwardly from the wheel towards the tire.

As shown in FIG. 6, the end of each arcuate band which makes up the runflat band has a hook 120 formed on it with a longitudinal opening 121 formed therein and an aperture 122 set back from the hook 120. In a standard configuration, a threaded shaft extends between adjacent ends of the bands, through the openings 121 and nuts engage in the apertures 122 so as to retain the shaft in place. The assembly consists of a bolt, a toggle that engages in the apertures which is then tightened by the nut. The link member 100 replaces the shaft and nuts, with the hook 120 on the end of one of the band member hooking over the adjacent end body 104 and engaging on either side of the arm 102b so that the arm 102b extends through the longitudinal opening 121 and the end body 104 engages in the aperture 120. The tension in the band and the greater width of the end body 104 compared with the opening 121 then holds the link in place. As shown in FIG. 6, a standard connecting bar is used on the other side of the band so as to enable adjustment of the band in a conventional manner.

In an alternative embodiment which is not shown, the end bodies are eliminated and the arms replaced by threaded shafts which connect to the band members using nuts in a conventional manner.

What is claimed is:

1. A removable wheel well filler comprising:
a band member having at least one gap between two ends thereof, so as to enable it to be circumferentially fitted onto a wheel;
a link member adapted for connecting said ends of said band member to bridge the gap and thereby secure the band, in use, on a wheel; and
a wireless device coupled to said link member and being remotely interrogatable to confirm the presence of the filler on the wheel.

2. The wheel well filler according to claim 1, wherein the link member comprises a central block on which the wireless device is mounted and two side blocks, on opposing sides of and connected to the central block by arms whose width is smaller than the width of the central and side blocks.

3. The wheel well filler according to claim 1, wherein the link member is formed with a central member on which the wireless device is mounted and threaded shafts extending from opposing sides thereof

4. The wheel well filler according to claim 1, further comprising:
a hub, and a tire mounted on the hub so as to cooperatively form an air tight chamber of a wheel assembly; wherein said band member comprises a run flat safety band mounted on the hub in the air tight chamber.

5. The wheel well filler according to claim 4, further comprising:
means for confirming the presence of a run flat safety band on a wheel assembly by emitting an interrogation signal in the region of the wheel assembly and monitoring for a response signal from the wireless device, the detection of a response signal confirming the presence of run flat safety band on the hub.

6. An apparatus for a wheel comprising a link member for a wheel well filler or runflat safety band having ends for connection between ends of at least one band member which forms the wheel well filler/runflat safety band and a wireless device attached to the link member, which wireless device is remotely interrogatable in order to confirm the presence of the filler on the wheel.

7. The apparatus according to claim 6, wherein the link member comprises a central block on which the wireless device is mounted and two side blocks, on opposing sides of and connected to the central block by arms whose width is smaller than the width of the central and side blocks.

8. The apparatus according to claim 7, wherein the link member is formed with a central member on which the wireless device is mounted and threaded shafts extending from opposing sides thereof
